(19) United States
(12) Patent Application Publication
(10) Pub. No.: US 2025/0390052 A1
(43) Pub. Date: Dec. 25, 2025

(54) IMAGE FORMING SYSTEM

(71) Applicant: KONICA MINOLTA, INC., Tokyo (JP)

(72) Inventor: Akihiko SHIMAZU, Tokyo (JP)

(21) Appl. No.: 19/206,273

(22) Filed: May 13, 2025

(30) Foreign Application Priority Data
May 22, 2024 (JP) 2024-083052

(51) Int. Cl. G03G 15/00; G03G 21/20

(52) U.S. Cl. CPC G03G 15/6573; G03G 15/50; G03G 15/6579; G03G 21/20; G03G 2215/00679

(57) ABSTRACT

The present invention provides an image forming system including: a fixer that heats and fixes a toner image onto a recording medium; and a low-thermal-conductivity conveyance roller that conveys the recording medium while holding the recording medium at a formed nip, the low-thermal-conductivity conveyance roller having a lower thermal conductivity than one or a plurality of other conveyance rollers located downstream of the fixer and being provided in a predetermined region downstream of the fixer where the toner image that has been heated and fixed reaches a glass transition temperature.

### CROSS REFERENCE TO RELATED APPLICATIONS

The present invention claims priority under 35 U.S.C. § 119 to Japanese Patent Application No. 2024-083052 filed on May 22, 2024, the entire content of which is incorporated herein by reference.

### BACKGROUND OF THE INVENTION

### 1. Technical Field

The present invention relates to an image forming system.

### 2. Description of Related Art

An image forming apparatus using an electrophotographic method, for example, develops an electrostatic latent image formed by exposing a charged photoreceptor with toner to form a toner image on the surface of the photoreceptor, transfers the toner image to an intermediate transfer member, and then transfers the toner image to a sheet from the intermediate transfer member. Thereafter, the image forming apparatus performs fixing processing for heating and pressurizing the toner image on the sheet to fix the toner image on the sheet, thereby forming an image on the sheet.

In a case where the toner image contacts a conveyance roller at a timing at which the toner reaches a glass transition temperature during conveyance of the sheet having the toner image fixed thereon, a difference in a cooling state of wax included in the toner occurs between a contact portion and a non-contact portion, which may cause image unevenness.

The following prior art is disclosed in Japanese Unexamined Patent Application Publication No. 2008-129091. A conveyance roller member provided downstream of a fixer for fixing a toner image on a sheet and rotating in contact with the toner fixing surface of the sheet that is conveyed with the toner image fixed thereon is disposed upstream of a position where the toner image reaches a glass transition temperature in the sheet conveyance direction. The conveyance roller member is composed of a core material and a surface layer material formed of a resin material covering the core material. Thus, the thermal conductivity of the surface of the conveyance roller member is reduced, whereby a temperature difference between a portion where the conveyance roller member contacts toner having a temperature higher than the glass transition temperature and the other portion can be reduced. Therefore, the generation of a roller mark by the conveyance roller member can be suppressed.

### SUMMARY OF THE INVENTION

Meanwhile, when the toner image reaches the glass transition temperature, the state of the toner becomes more unstable. Therefore, when a temperature difference occurs in the toner image that has reached the glass transition temperature, the possibility of the occurrence of image unevenness increases. In the configuration disclosed in the above-described prior art, it is necessary not to provide a conveyance roller or a conveyance roller member in a region where the toner image reaches the glass transition temperature, and thus restriction is imposed on a layout of members for conveyance. Furthermore, although the above-described prior art reduces the thermal conductivity of the surface of the conveyance roller member, the contact state of the conveyance roller member with the sheet becomes relatively unstable, and therefore, there still remains a possibility that image unevenness occurs. In addition, since the conveyance roller member does not have a driving force to convey the sheet, the temperature of the toner image on the sheet needs to be decreased to be less than the glass transition temperature before the sheet is conveyed to a drive roller that comes into contact with the sheet for the first time on the downstream side from the fixer.

The present invention has been made to solve such problems. That is, an object of the present invention is to provide an image forming system capable of effectively preventing the occurrence of image unevenness while suppressing restrictions on the layout of members for conveyance.

To achieve at least one of the abovementioned objects, according to an aspect of the present invention, an image forming system reflecting one aspect of the present invention comprises the followings.

An image forming system including: a fixer that heats and fixes a toner image onto a recording medium; and a low-thermal-conductivity conveyance roller that conveys the recording medium while holding the recording medium at a formed nip, the low-thermal-conductivity conveyance roller having a lower thermal conductivity than one or a plurality of other conveyance rollers located downstream of the fixer and being provided in a predetermined region downstream of the fixer where the toner image that has been heated and fixed reaches a glass transition temperature.

### BRIEF DESCRIPTION OF THE DRAWINGS

The advantages and features provided by one or more embodiments of the present invention will be more fully understood from the following detailed description and the accompanying drawings. However, these are for purposes of illustration only and are not intended to limit the present invention.

FIG. 1 is a schematic diagram illustrating a configuration of an image forming apparatus;

FIG. 2 is a block diagram illustrating the configuration of the image forming apparatus;

FIG. 3 is an explanatory diagram illustrating a state of toner on a graph indicating a relationship between temperature and hardness of toner;

FIG. 4 is a partial enlarged view of a sheet conveyor including an ADU conveyance path;

FIG. 5 is a schematic diagram illustrating a configuration of an image forming apparatus; and

FIG. 6 is a schematic diagram illustrating a configuration of an image forming apparatus and a charge adjustment device.

### DETAILED DESCRIPTION

Embodiments of an image forming system according to the present invention will be described below with reference to the drawings. It is to be noted that the scope of the present invention is not limited to the embodiments to be described. In the drawings, the same components are denoted by the same reference signs, and redundant description is omitted. In addition, dimensional ratios in the drawings are exaggerated for convenience of description and may be different from actual ratios.

### First Embodiment

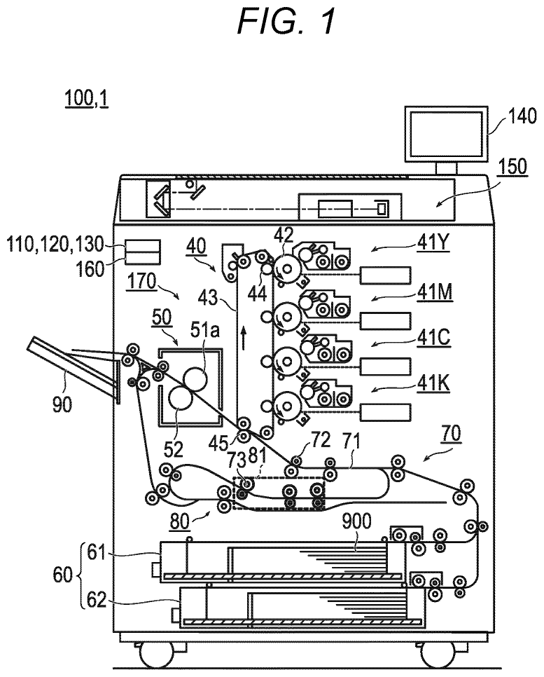

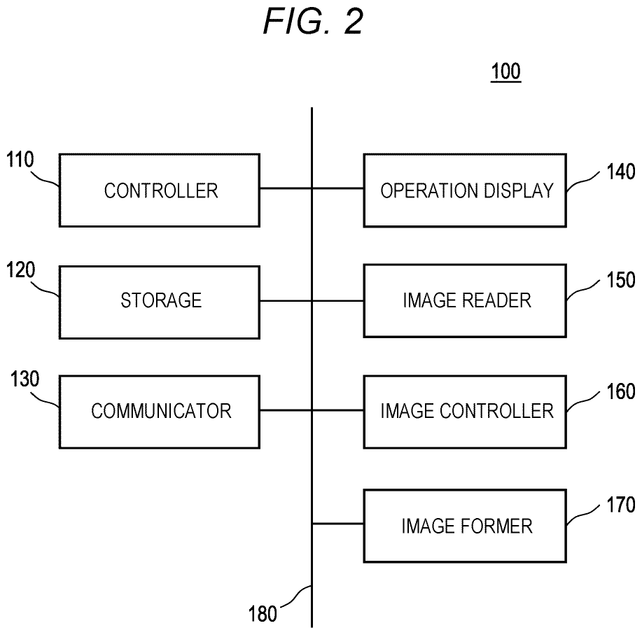

FIG. 1 is a schematic diagram illustrating the configuration of an image forming apparatus 100. FIG. 2 is a block diagram illustrating the configuration of the image forming apparatus 100. The image forming apparatus 100 constitutes an image forming system 1. That is, the image forming system 1 may be composed of only the image forming apparatus 100.

The image forming apparatus 100 includes a controller 110, a storage 120, a communicator 130, an operation display 140, an image reader 150, an image controller 160, and an image former 170. These constituent elements are communicably connected to each other via a bus 180. The image forming apparatus 100 may be implemented by a multifunction peripheral (MFP).

The controller 110 includes a central processing unit (CPU) and various memories and performs control of the above-described sections and various types of arithmetic processing in accordance with a program.

The storage 120 includes a solid state drive (SDD) or a hard disc drive (HDD) and stores various programs and various types of data.

The communicator 130 is an interface for enabling communication between the image forming apparatus 100 and an external device. As the communicator 130, a network interface compliant with a standard such as Ethernet (registered trademark), SATA, or IEEE1394 is used. As the communicator 130, various kinds of local connection interfaces including wireless communication interfaces such as Bluetooth (registered trademark) and IEEE802.11 may be used.

The operation display 140 includes a touch screen, a numeric keypad, a start button, a stop button, and the like, and is used for displaying various kinds of information and inputting various instructions.

The image reader 150 includes a light source such as a fluorescent lamp and an imaging element such as a charge coupled device (CCD) image sensor. The image reader 150 irradiates a document set at a predetermined reading position with light from the light source, photoelectrically converts the reflected light with the imaging element, and generates image data from the electrical signal.

The image controller 160 performs layout and rasterization of print data included in a print job or the like received from the communicator 130 and generates image data in a bitmap format.

The print job is a generic term for a printing instruction to be given to the image forming apparatus 100 and includes print data and print setting. The print data is data of a document to be printed, and the print data can include various kinds of data such as image data, vector data, and text data. Specifically, the print data may be page description language (PDL) data, portable document format (PDF) data, or tagged image file format (TIFF) data. The print setting is a setting related to image formation on a sheet 900 and includes various settings such as the number of pages, the number of printed copies, a paper type, selection of color or monochrome, double-sided printing, and page layout.

The image former 170 includes an image forming section 40, a fixer 50, a sheet feeder 60, and a sheet conveyor 70. The sheet conveyor 70 forms a conveyance path for conveying the sheet 900 by a plurality of conveyance rollers 72.

The image forming section 40 includes image forming units 41Y, 41M, 41C, and 41K corresponding to toners of respective colors of Y (yellow), M (magenta), C (cyan), and K (black). Each of the image forming units 41Y, 41M, 41C, and 41K performs charging, exposure, and developing processes to form a toner image on a photosensitive drum 42 on the basis of image data. Exposure is performed by scanning the surface of the photosensitive drum 42 with a laser beam. The toner images formed on the photosensitive drums 42 are sequentially superimposed and primarily transferred onto an intermediate transfer belt 43 by an electrostatic force generated by a transfer voltage that is controlled to be a constant voltage and that is applied to a primary transfer roller 44. Thus, a color toner image is retained on the intermediate transfer belt 43. The color toner image on the intermediate transfer belt 43 is secondarily transferred onto the sheet 900 by a secondary transfer roller 45.

The fixer 50 includes a fixing roller 51a and a pressure roller 52, and the fixing roller 51a and the pressure roller 52 are pressed against each other to form a nip between the fixing roller 51a and the pressure roller 52. The fixer 50 heats and pressurizes, at the nip, the sheet 900 conveyed to the nip, and rotates the fixing roller 51a and the pressure roller 52, thereby heating and fixing the toner image on the sheet 900 to the front side of the sheet 900.

The sheet 900 on which the toner image has been heated and fixed is ejected to a sheet ejection tray 90 by the conveyance rollers 72.

When double-sided printing is set in the print setting of the print job, the sheet conveyor 70 conveys the sheet 900 having a toner image heated and fixed on its front side to an auto duplex unit (ADU) conveyance path 80. The sheet 900 conveyed to the ADU conveyance path 80 is turned upside down by a switchback path and then conveyed to the conveyance path 71, and an image is again formed on the back side of the sheet by the image former 170. The ADU conveyance path 80 constitutes a double-sided circulation conveyance path.

The temperature of the toner image heated and fixed on the front side of the sheet 900 by the fixer 50 decreases with time and reaches the glass transition point. More specifically, the temperature of wax contained in the toner forming the toner image decreases, and the wax reaches the glass transition point.

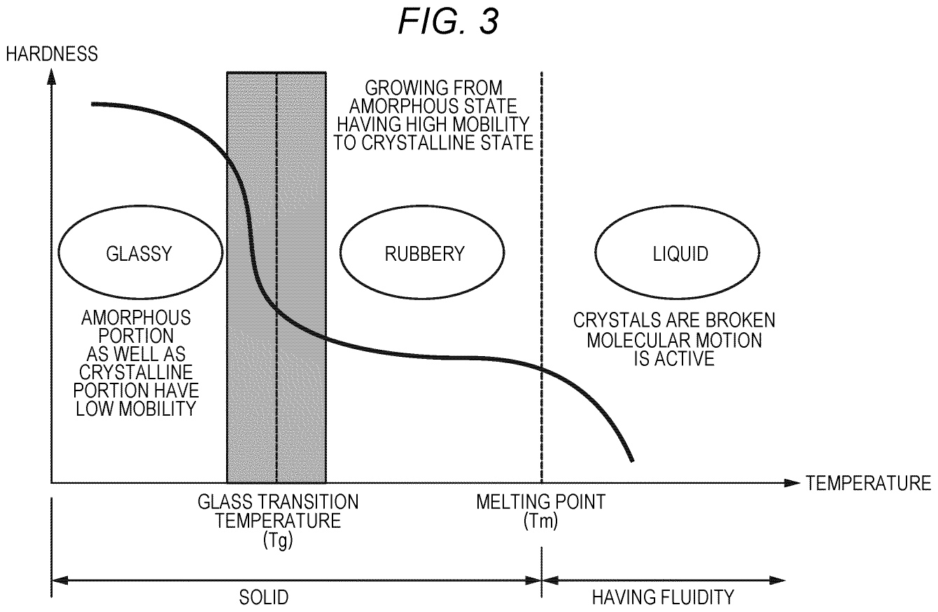

FIG. 3 is an explanatory diagram illustrating a state of toner on a graph indicating a relationship between temperature and hardness of toner.

Toner transitions to a liquid state at a temperature equal to or higher than a melting point Tm. At this time, the toner has fluidity, the crystals of the wax are broken, and the molecular motion is active. The toner transitions to a rubbery state at a temperature lower than the melting point and higher than the glass transition temperature Tg. At this time, the toner is solid, but grows from an amorphous state having high mobility to a crystalline state as the temperature decreases. The toner transitions to a glassy state at a glass transition temperature Tg or less. At this time, the toner is solid, and both the crystalline portion and the amorphous portion have low mobility.

The state of the toner becomes more unstable when the toner image reaches the glass transition temperature, and thus, when a temperature difference occurs in the toner image that has reached the glass transition temperature, the possibility of the occurrence of image unevenness further increases. Therefore, in order to prevent the occurrence of image unevenness, it is important not to cause a temperature difference in the toner image when the toner image reaches the glass transition temperature.

When the sheet 900 is held at the nip of the conveyance roller 72 at the time point at which the temperature of the toner image reaches the glass transition temperature after the toner image is heated and fixed on the sheet 900, the toner image on the sheet 900 may be locally deprived of heat due to contact with the conveyance roller 72. Thus, a temperature difference may occur between a portion of the toner image on the sheet 900 contacting the conveyance roller 72 and a portion of the toner image not contacting the conveyance roller 72. Even if the conveyance roller 72 is wider than the maximum image width, a contact state between the conveyance roller 72 and the sheet 900 can be partially different due to, for example, bending of a rotating shaft of the roller caused by formation of the nip. Therefore, even when the conveyance roller 72 is wider than the maximum image width, the temperature difference may occur.

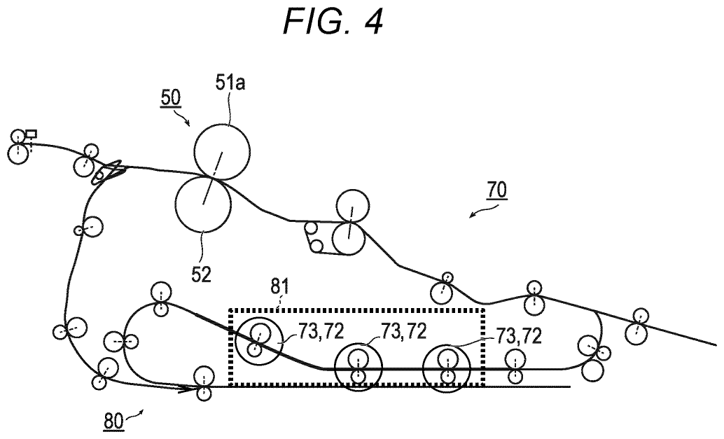

FIG. 4 is a partial enlarged view of the sheet conveyor 70 including the ADU conveyance path 80.

FIG. 4 illustrates, in a broken line, a glass transition point temperature arrival region 81 where the toner image on the sheet 900 being conveyed reaches the glass transition point temperature. It is sufficient that the glass transition point temperature arrival region 81 includes a point at which the toner image reaches the glass transition point temperature. The glass transition point temperature arrival region 81 defines a “predetermined region”. The glass transition point temperature arrival region 81 can change depending on the conveyance speed of the sheet 900 or the like.

In the example of FIG. 4, the glass transition point temperature arrival region 81 refers to a position in the ADU conveyance path 80 where the sheet 900 whose conveyance direction has been reversed is conveyed.

As the conveyance roller 72 provided in the glass transition point temperature arrival region 81, a low-thermal-conductivity conveyance roller 73 having a lower thermal conductivity than one or a plurality of other conveyance rollers 72 located downstream of the fixer 50 is used. That is, the low-thermal-conductivity conveyance roller 73 having a lower thermal conductivity than one or a plurality of other conveyance rollers located downstream of the fixer 50 is provided, the low-thermal-conductivity conveyance roller 73 being provided in a predetermined region downstream of the fixer 50 where the toner image reaches the glass transition temperature, and conveying the sheet 900 while holding the sheet 900 at the formed nip. Thus, it is possible to effectively prevent the occurrence of image unevenness by suppressing heat absorption from the toner image by the conveyance roller 72 and making the contact state of a conveyance member with the toner image constant while suppressing the restriction on the layout of members for conveyance. The low-thermal-conductivity conveyance roller 73 preferably has the lowest thermal conductivity among the conveyance rollers 72 located downstream of the fixer 50.

The low-thermal-conductivity conveyance roller 73 is constituted by, for example, a roller having a roller surface that is formed of a resin material having a porous structure. In this case, the conveyance rollers 72 other than the low-thermal-conductivity conveyance roller 73 on the downstream side of the fixer 50 are constituted by, for example, rollers having roller surfaces that are formed of a rubber material such as urethane.

Only a roller to come into contact with the toner image among a plurality of rollers, which forms a nip, of the low-thermal-conductivity conveyance roller 73 may have a lower thermal conductivity than one or a plurality of other conveyance rollers 72 located downstream of the fixer 50. Thus, it is possible to prevent the occurrence of image unevenness while suppressing an increase in the cost of the apparatus.

As described above, in the example of FIG. 4, the glass transition point temperature arrival region 81 refers to a position in the ADU conveyance path 80 where the sheet 900 whose conveyance direction has been reversed is conveyed. Therefore, the low-thermal-conductivity conveyance roller 73 is provided at a position in the ADU conveyance path 80 where the sheet 900 whose conveyance direction has been reversed is conveyed. The low-thermal-conductivity conveyance roller 73 provided at the position in the ADU conveyance path 80 where the sheet 900 whose conveyance direction has been reversed is conveyed is controlled to be decelerated and stopped by the controller 110. As the toner image on the sheet 900 is held between the rollers for a longer time in a state where the toner image has reached the glass transition temperature, a temperature difference may increase between a portion of the toner image in contact with the rollers and a portion of the toner image not in contact with the rollers. In view of this, the low-thermal-conductivity conveyance roller 73 is used as the conveyance roller 72 that is controlled to be decelerated and stopped and that is provided at the position in the ADU conveyance path 80 where the sheet 900 whose conveyance direction has been reversed is conveyed. With this configuration, the effect of preventing an occurrence of image unevenness can be increased.

The low-thermal-conductivity conveyance roller 73 can be wider than the maximum image width. Thus, the low-thermal-conductivity conveyance roller 73 has no portion that does not contact the toner image, whereby the occurrence of image unevenness can be suppressed.

The low-thermal-conductivity conveyance roller 73 may be constituted by a plurality of rollers each of which has a width narrower than the maximum image width, the plurality of rollers being arranged so as to be separated from each other in a direction perpendicular to the conveyance direction of the sheet 900. In this case, the effect of preventing the occurrence of image unevenness by using the low-thermal-conductivity conveyance roller 73 as the roller can be increased.

The low-thermal-conductivity conveyance roller 73 may be variable in nip pressure. The nip pressure can be changed, for example, by changing a distance between shafts of a pair of rollers constituting the low-thermal-conductivity conveyance roller 73 using a cam or the like. If the effect of preventing image unevenness by the low-thermal-conductivity conveyance roller 73 is insufficient, the nip pressure of the low-thermal-conductivity conveyance roller 73 can be reduced. Thus, the nip width in which the sheet 900 and the low-thermal-conductivity conveyance roller 73 contact each other can be narrowed, so that the effect of preventing image unevenness by the low-thermal-conductivity conveyance roller 73 can be improved. The effect of preventing image unevenness by the low-thermal-conductivity conveyance roller 73 can also be improved by separating the rollers forming the nip of the low-thermal-conductivity conveyance roller 73 to set the nip pressure to 0.

A plurality of the low-thermal-conductivity conveyance rollers 73 can be continuously arranged in the conveyance direction of the sheet 900. In the example of FIG. 4, three low-thermal-conductivity conveyance rollers 73 are continuously arranged in the conveyance direction of the sheet 900. At a temperature around the glass transition point of toner, the toner relatively smoothly transitions from a rubbery state to a glassy state, and the hardness also relatively smoothly varies. Therefore, the effect of preventing image unevenness can be further improved by continuously arranging a plurality of low-thermal-conductivity conveyance rollers 73 in the conveyance direction of the sheet 900.

### Second Embodiment

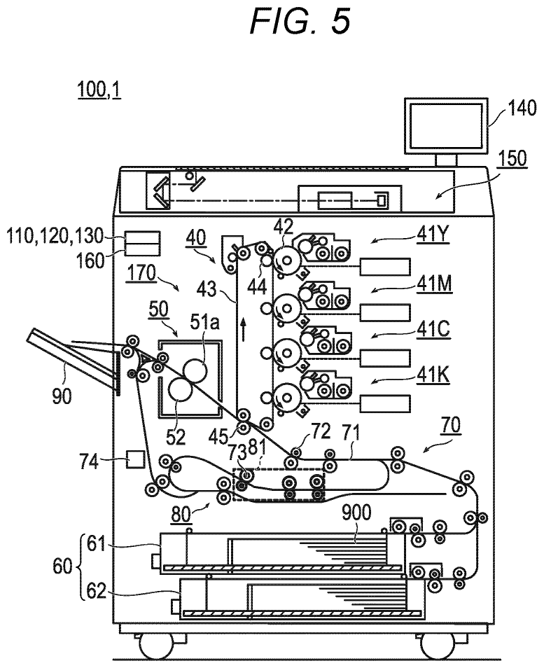

A second embodiment will be described. The present embodiment is different from the first embodiment in the following points. In the present embodiment, a cooler 74 (see FIG. 5) is provided downstream of the fixer 50 and upstream of the low-thermal-conductivity conveyance roller 73. In other respects, the present embodiment is similar to the first embodiment, and therefore, redundant description is omitted.

FIG. 5 is a schematic diagram illustrating the configuration of an image forming apparatus 100.

As illustrated in FIG. 5, the cooler 74 is provided downstream of the fixer 50 and upstream of the low-thermal-conductivity conveyance roller 73. There may be a case where different sheet materials such as coated paper and synthetic paper are used as a sheet 900, a case where sheets 900 having different basis weights such as thin paper and thick paper are used, and a case where toner amounts of toner images are different. In such cases, a glass transition point temperature arrival region 81 may fluctuate.

In the present embodiment, the temperature of the sheet 900 is controlled by the cooler 74 provided downstream of the fixer 50 and upstream of the low-thermal-conductivity conveyance roller 73. Thus, it is possible to prevent fluctuation of the glass transition point temperature arrival region 81. The cooler 74 may include, for example, a fan. The temperature of the sheet 900 can be controlled by a controller 110 controlling electric power supplied to the fan serving as the cooler 74 so that the glass transition point temperature arrival region 81 is defined as a predetermined region.

### Third Embodiment

A third embodiment will be described. The present embodiment is different from the first embodiment in the following points. In the present embodiment, a charge adjustment device 200 that adjusts charges on a sheet 900 having an image formed thereon by an image forming apparatus 100 is provided, and as a charging roller 220 of the charge adjustment device 200, a low-thermal-conductivity conveyance roller 73 is used. In other respects, the present embodiment is similar to the first embodiment, and therefore, redundant description is omitted.

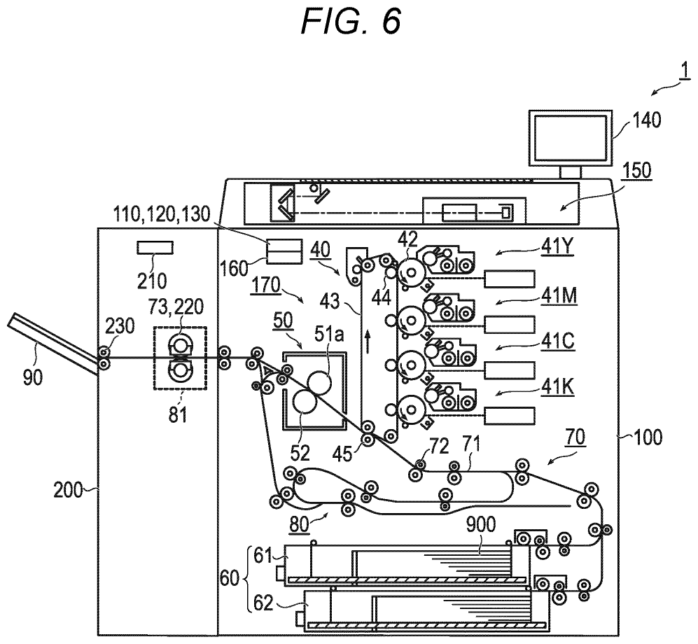

FIG. 6 is a schematic diagram illustrating configurations of the image forming apparatus 100 and the charge adjustment device 200.

The image forming apparatus 100 and the charge adjustment device 200 constitute an image forming system 1.

The charge adjustment device 200 includes a controller 210, a charging roller 220, and a sheet ejection roller 230. The sheet ejection roller 230 also conveys the sheet 900, and therefore also functions as a conveyance roller 72.

The charging roller 220 charges the sheet 900 on which an image has been formed by the image forming apparatus 100 in order to prevent the sheets 900 from sticking to each other. When passing through the nip of the charging roller 220, the sheet 900 is charged. Thus, the charge of the sheet 900 is adjusted. A charge adjustment power source (not illustrated) is connected to the charging roller 220. The charging roller 220 also serves as the conveyance roller 72 for conveying the sheet 900.

In a case where the charge adjustment device 200 is included, a roller in the charge adjustment device 200 can be a roller provided in the glass transition point temperature arrival region 81. Therefore, in the present embodiment, the low-thermal-conductivity conveyance roller 73 is used as the charging roller 220 provided in the glass transition point temperature arrival region 81. The charging roller 220 is constituted by a roller having a roller surface that is formed of a resin material having a porous structure. Thus, the charging roller 220 serves as the low-thermal-conductivity conveyance roller 73 having a lower thermal conductivity than one or a plurality of other conveyance rollers 72 and the sheet ejection roller 230 located downstream of the fixer 50. In this case, the conveyance rollers 72 and the sheet ejection roller 230 other than the low-thermal-conductivity conveyance roller 73 on the downstream side of the fixer 50 can be constituted by rollers whose roller surfaces are formed of a rubber material such as urethane, for example.

The embodiments have the following effects.

A low-thermal-conductivity conveyance roller having a lower thermal conductivity than one or a plurality of other conveyance rollers located downstream of the fixer is provided in a predetermined region downstream of the fixer where a toner image that has been heated and fixed reaches a glass transition point. Thus, it is possible to effectively prevent the occurrence of image unevenness by suppressing heat absorption from the toner image by the conveyance roller and making the contact state of the conveyance member with the toner image constant while suppressing the restriction on the layout of members for conveyance.

In addition, the low-thermal-conductivity conveyance roller is variable in nip pressure. Thus, the nip width can be narrowed, so that the effect of preventing image unevenness by the low-thermal-conductivity conveyance roller can be improved. In addition, the effect of preventing image unevenness by the low-thermal-conductivity conveyance roller can be improved by separating the rollers forming the nip of the low-thermal-conductivity conveyance roller to set the nip pressure to 0.

The low-thermal-conductivity conveyance roller is constituted by a roller that has a roller surface formed of a resin material having a porous structure. Thus, the effect of preventing image unevenness can be effectively improved.

In addition, the low-thermal-conductivity conveyance roller is wider than the maximum image width. Thus, the low-thermal-conductivity conveyance roller 73 has no portion that does not contact the toner image, whereby the occurrence of image unevenness can be suppressed.

In addition, the low-thermal-conductivity conveyance roller is constituted by a plurality of rollers each of which has a width narrower than the maximum image width, the plurality of rollers being arranged so as to be separated from each other in a direction perpendicular to the conveyance direction of a recording medium. Thus, the effect of preventing the occurrence of image unevenness by using the low-thermal-conductivity conveyance roller as the roller can be increased.

Furthermore, the image forming system includes a controller that at least decelerates or stops the low-thermal-conductivity conveyance roller. Thus, the effect of preventing the occurrence of image unevenness can be increased by using the low-thermal-conductivity conveyance roller as the conveyance roller at a position where the conveyance roller is controlled to be at least decelerated or stopped.

The low-thermal-conductivity conveyance roller is provided at a position in the double-sided circulation conveyance path where the recording medium whose conveyance direction has been reversed is conveyed. Thus, the occurrence of image unevenness can be effectively prevented in a simple manner.

Furthermore, the image forming system includes a cooler that is provided downstream of the fixer and upstream of the low-thermal-conductivity conveyance roller and that cools the recording medium. Thus, it is possible to prevent fluctuation of the glass transition point temperature arrival region.

Furthermore, the low-thermal-conductivity conveyance roller is configured such that only a roller to come into contact with the toner image among a plurality of rollers forming the nip has a lower thermal conductivity than one or a plurality of other conveyance rollers located downstream of the fixer. Thus, it is possible to prevent the occurrence of image unevenness while suppressing an increase in the cost of the apparatus.

A plurality of low-thermal-conductivity conveyance rollers is continuously arranged in the conveyance direction of the recording medium. Thus, the effect of preventing image unevenness can be further improved.

The present invention is not limited to the above-described embodiments.

For example, the low-thermal-conductivity conveyance roller 73 only needs to have a lower thermal conductivity than one or a plurality of other conveyance rollers 72 located downstream of the fixer 50 and is not limited to have a surface formed of a resin material that has a porous structure. Therefore, the low-thermal-conductivity conveyance roller 73 can be implemented using any roller having a lower thermal conductivity than one or a plurality of other conveyance rollers 72 located downstream of the fixer 50 by selecting materials, structures, or the like.

While the embodiments of the present invention have been described and illustrated in detail, the disclosed embodiments have been created for purposes of illustration and example only, and not limitation. The scope of the present invention is to be interpreted by the wording of the appended claims.

What is claimed is:

1. An image forming system comprising:
a fixer that heats and fixes a toner image onto a recording medium; and
a low-thermal-conductivity conveyance roller that conveys the recording medium while holding the recording medium at a formed nip, the low-thermal-conductivity conveyance roller having a lower thermal conductivity than one or a plurality of other conveyance rollers located downstream of the fixer and being provided in a predetermined region downstream of the fixer where the toner image that has been heated and fixed reaches a glass transition temperature.

2. The image forming system according to claim 1, wherein the low-thermal-conductivity conveyance roller is variable in nip pressure.

3. The image forming system according to claim 1, wherein the low-thermal-conductivity conveyance roller has a roller surface that is formed of a resin material having a porous structure.

4. The image forming system according to claim 1, wherein the low-thermal-conductivity conveyance roller is wider than a maximum image width.

5. The image forming system according to claim 1, wherein the low-thermal-conductivity conveyance roller includes a plurality of rollers each having a width narrower than a maximum image width, the plurality of rollers being arranged so as to be separated from each other in a direction perpendicular to a conveyance direction of the recording medium.

6. The image forming system according to claim 1, further comprising a controller that at least decelerates or stops the low-thermal-conductivity conveyance roller.

7. The image forming system according to claim 1, wherein the low-thermal-conductivity conveyance roller is provided at a position in a double-sided circulation conveyance path where the recording medium whose conveyance direction has been reversed is conveyed.

8. The image forming system according to claim 1, further comprising a cooler that cools the recording medium, the cooler being provided downstream of the fixer and upstream of the low-thermal-conductivity conveyance roller.

9. The image forming system according to claim 1, wherein the low-thermal-conductivity conveyance roller is configured such that only a roller to come into contact with the toner image among a plurality of rollers forming the nip has a lower thermal conductivity than one or a plurality of other conveyance rollers located downstream of the fixer.

10. The image forming system according to claim 1, wherein a plurality of the low-thermal-conductivity conveyance rollers is continuously arranged in a conveyance direction of the recording medium.
